(19) United States
(12) Patent Application Publication
(10) Pub. No.: US 2017/0324899 A1
(43) Pub. Date: Nov. 9, 2017

(54) IMAGE PICKUP APPARATUS, HEAD-MOUNTED DISPLAY APPARATUS, INFORMATION PROCESSING SYSTEM AND INFORMATION PROCESSING METHOD

(71) Applicant: Sony Interactive Entertainment Inc., Tokyo (JP)

(72) Inventor: Akio OHBA, Kanagawa (JP)

(73) Assignee: Sony Interactive Entertainment Inc., Tokyo (JP)

(21) Appl. No.: 15/427,416

(22) Filed: Feb. 8, 2017

(30) Foreign Application Priority Data
May 9, 2016 (JP) 2016-094079

(51) Int. Cl. H04N 5/232; H04N 5/225; H04N 5/265; H04N 5/247

(52) U.S. Cl. CPC H04N 5/23238; H04N 5/265; H04N 5/247; H04N 5/2252; H04N 5/23245; H04N 5/23293

(57) ABSTRACT

Disclosed herein is an image pickup apparatus adapted to pick up an image to be used for generation of a display image at a predetermined rate, the image pickup apparatus including: a first camera configured to pick up an image of an image pickup object space; a second camera configured to pick up an image of the image pickup object space with a wider field of view and a lower resolution than those of the first camera; and an outputting unit configured to successively output data of the images picked up by the first camera and the second camera.

### BACKGROUND

The present disclosure relates to an image pickup apparatus, a head-mounted display apparatus, an information processing system and an information processing method used for image processing which involves generation of a display image.

A system has been developed wherein a panoramic image is displayed on a head-mounted display apparatus and, if a user who has the head-mounted display apparatus mounted thereon turns its head, then a panoramic image according to the direction of a line of sight of the user is displayed. Where the head-mounted display apparatus is used, it is possible to increase the sense of immersion to the image or to improve the operability of an application of a game or the like. Also a walk-through system has been developed wherein, if a user who has a head-mounted display apparatus mounted thereon moves physically, then the user can virtually walk around in a space displayed as an image.

### SUMMARY

In order to improve an image representation using a head-mounted display apparatus so as to have higher quality and provide higher presence, it is demanded to increase the angle of view and the definition of a display image. Where the amount of data to be handled is fixed, the parameters of them have a tradeoff relationship to each other. If it is tried to improve one of them while the other is maintained or to improve both of them, then the amount of data to be handled increases. This may give rise to a problem that increased time is required for image processing and data transmission or that an actual motion of a user and display of an image are displaced from each other.

There is a need for the present disclosure to provide a technology which can improve both of the angle of view and the definition of a display image, and the immediacy of display.

In order to attain the subject described above, an embodiment of the present disclosure relates to an image pickup apparatus. The image pickup apparatus is an image pickup apparatus for picking up an image to be used for generation of a display image at a predetermined rate, including a first camera configured to pick up an image of an image pickup object space, a second camera configured to pick up an image of the image pickup object space with a wider field of view and a lower resolution than those of the first camera, and an outputting unit configured to successively output data of the images picked up by the first camera and the second camera.

Another embodiment of the present disclosure relates to a head-mounted display apparatus. The head-mounted display apparatus includes the image pickup apparatus described above, and a display unit configured to display a display image synthesized from an image picked up by the first camera and an image picked up by the second camera.

Also a further embodiment of the present disclosure relates to a head-mounted display apparatus. The head-mounted display apparatus includes a first display unit and a second display unit each configured to display an image, and a first reflector and a second reflector configured to reflect the images displayed by the first display unit and the second display unit in a direction toward the eyes of a user, respectively, and wherein the first reflector is smaller than the second reflector and is disposed between the eyes of the user and the second reflector.

A still further embodiment of the present disclosure relates to an information processing system. The information processing system includes the image pickup apparatus described above, and an information processing apparatus configured to acquire data of an image outputted from the image pickup apparatus, synthesize the image picked up by the first camera and the image picked up by the second camera to generate a display image, and output the display image to a display apparatus.

A yet further embodiment of the present disclosure relates to an information processing system. The information processing system includes the head-mounted display apparatus described above, and an information processing apparatus configured to generate images to be displayed on the first display unit and the second display unit and output the images to the head-mounted display apparatus.

A different embodiment of the present disclosure relates to an information processing method. The information processing method includes acquiring data of images picked up by a first camera configured to pick up an image of an image pickup object space and a second camera configured to pick up an image of the image pickup object space with a wider field of view and a lower resolution than those of the first camera, generating a display image by synthesizing the image picked up by the first camera and the image picked up by the second camera, and outputting data of the display image to a display apparatus.

It is to be noted that arbitrary combinations of the components described above and conversions of the representation of the present disclosure between arbitrary ones of a method, an apparatus, a system, a computer program, a data structure, a recording medium and so forth are effective as modes of the present disclosure.

With the present disclosure, all of the angle of view and the definition of a display image and the immediacy of display can be improved.

### BRIEF DESCRIPTION OF THE DRAWINGS

FIG. 1 is an appearance view of a head-mounted display apparatus of a first embodiment;

FIGS. 2A and 2B are views illustrating fields of view of a first camera and a second camera in the first embodiment;

FIG. 3 is a block diagram depicting a functional configuration of the head-mounted display apparatus of the first embodiment;

FIG. 4 is a schematic view depicting a configuration of an information processing system of the first embodiment;

FIG. 5 is a block diagram depicting a configuration of an internal circuit of an information processing apparatus of the first embodiment;

FIG. 6 is a block diagram depicting functional blocks of the information processing apparatus of the first embodiment;

FIG. 7 is a view schematically illustrating a procedure by an image generation unit in the first embodiment for generating a display image using a picked up image;

FIG. 8 is a view exemplifying an image generated finally by the image generation unit in order to implement a stereoscopic vision in the first embodiment;

FIG. 9 is a side elevational view schematically depicting an example of an internal configuration of a head-mounted display apparatus of a second embodiment;

FIG. 10 is a side elevational view schematically depicting another example of the internal configuration of the head-mounted display apparatus of the second embodiment;

FIG. 11 is a block diagram depicting functional blocks of an information processing apparatus of the second embodiment; and

FIG. 12 is a view illustrating a displacement which appears between two images depending upon the direction of a pupil in the second embodiment.

### DETAILED DESCRIPTION OF THE PREFERRED EMBODIMENTS

### First Embodiment

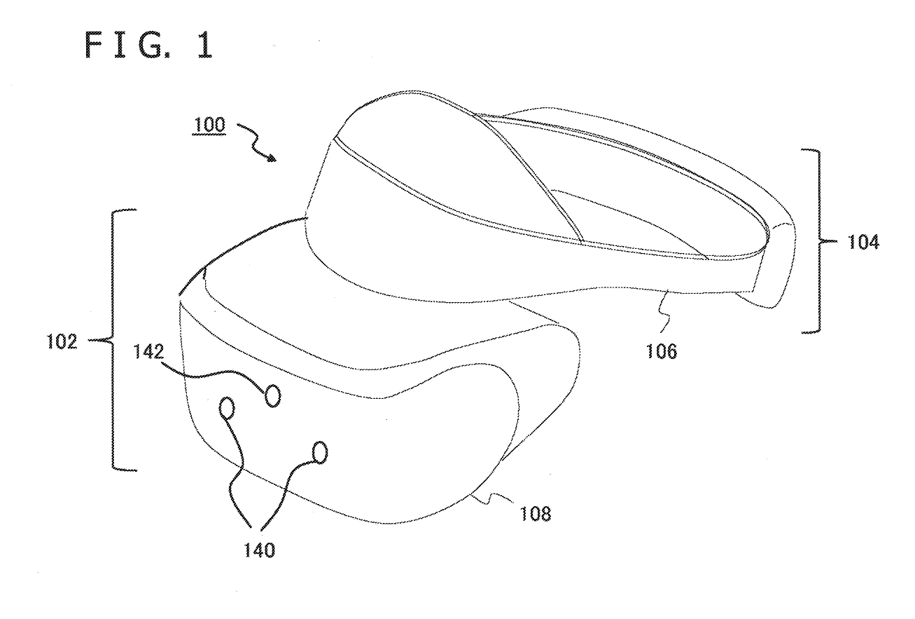

FIG. 1 depicts an example of an appearance shape of a head-mounted display apparatus according to a first embodiment. In the present embodiment, the head-mounted display apparatus 100 is configured from an outputting mechanism unit 102 and a mounting mechanism unit 104. The mounting mechanism unit 104 includes a mounting belt 106 which surrounds the head of a user to implement fixation of the head-mounted display apparatus 100 when the head-mounted display apparatus 100 is mounted on the head of the user. The mounting belt 106 is made of a material or has a structure which allows adjustment of the length of the mounting belt 106 in accordance with the circumference of the head of each user. For example, the mounting belt 106 may be formed from an elastic material such as rubber or may be formed using a buckle or a gear wheel.

The outputting mechanism unit 102 includes a housing 108 shaped such that it covers the left and right eyes of the user in a state in which the head-mounted display apparatus 100 is mounted on the user. The outputting mechanism unit 102 further includes a display panel provided in the inside thereof such that it directly faces the eyes of the user when the head-mounted display apparatus 100 is mounted on the user. The display panel is implemented by a liquid crystal display panel, an organic electroluminescence (EL) panel or the like. In the inside of the housing 108, a pair of lenses are positioned between the display panel and the eyes of the user when the head-mounted display apparatus 100 is mounted on the user such that the lenses magnify the viewing angle of the user. The head-mounted display apparatus 100 may further include a speaker and earphones at a position thereof corresponding to ears of the user when the head-mounted display apparatus 100 is mounted on the user.

The head-mounted display apparatus 100 further includes, on a front face of the outputting mechanism unit 102 thereof, a first camera 140 and a second camera 142 which have fields of view different from each other. The first camera 140 and the second camera 142 include an image pickup element such as a charge coupled device (CCD) element or a complementary metal oxide semiconductor (CMOS) element and pick up an image of an actual space at a predetermined frame rate with a field of view corresponding to the direction of the face of the user who mounts the head-mounted display apparatus 100 thereon.

The first camera 140 is configured from a stereo camera in which two cameras having a known distance therebetween are disposed on the left and right. Meanwhile, the second camera 142 has a lens disposed on a vertical line passing the midpoint between the two lenses of the stereo camera. Although the second camera 142 is disposed above the stereo camera in FIG. 1, the position of the second camera 142 is not limited to this. The second camera 142 has a field of view wider than that of the each cameras of the first camera 140.

Accordingly, if the first camera 140 and the second camera 142 have numbers of pixels similar to each other, then an image picked up by the second camera 142 has a lower resolution than that of images picked up from the points of view of the first camera 140. In the present embodiment, an image having a wide field of view but having a comparatively low resolution and images having a high resolution but having a narrow field of view are picked up simultaneously and are used complementarily to make necessary processing and displaying possible while the amount of data to be processed is suppressed. The former image and the latter image are hereinafter referred to as “wide angle image” and “narrow angle image,” respectively.

Images picked up by the first camera 140 and the second camera 142 can be used as at least part of a display image of the head-mounted display apparatus 100 and further can be used as input data for image analysis necessary for generation of a virtual world. For example, if the picked up images are used as a display image, then the user is placed into a state in which the user directly views an actual space in front of the user. Further, if an object which stays on an actual substance such as a desk included in the field of view or interacts with the actual substance is rendered on the picked up images to generate a display image, then augmented reality (AR) can be implemented.

Virtual reality (VR) can also be implemented by specifying the position and the posture of the head of a user having the head-mounted display apparatus 100 mounted thereon from the picked up images and rendering a virtual world by varying the field of view so as to cope with the position and the posture. As the technology for estimating the position or the posture of the cameras from picked up images, a popular technology such as visual simultaneous localization and mapping (v-SLAM) can be applied. The turning angle or the inclination of the head may be measured by a motion sensor built in or externally provided on the head-mounted display apparatus 100. A result of analysis of the picked up images and measurement values of the motion sensor may be utilized complementarily.

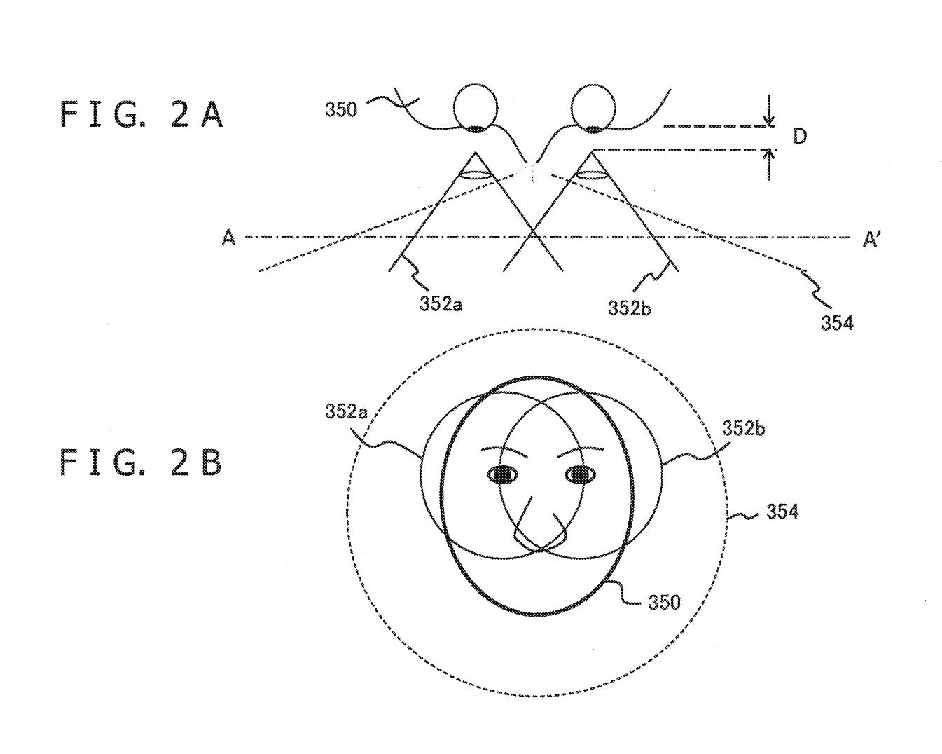

FIGS. 2A and 2B are views illustrating the fields of view of the first camera 140 and the second camera 142. In particular, the relationship between the point of view of a user 350 having the head-mounted display apparatus 100 mounted thereon and the fields of view of the each cameras is represented by an overhead view of FIG. 2A and a front elevational view of FIG. 2B. The first camera 140 picks up images of a space included in fields 352a and 252b of view from the left and right points of view corresponding to both eyes of the user 350. The second camera 142 picks up an image of a space included in a field 354 of view wider than the fields 352a and 252b of view. In the example depicted, the point of view is located in the proximity of a portion of the user 350 between the eyes.

If the field of view at a position of a dash-dot line A-A′ depicted in FIG. 2A is viewed from the front, then such a field of view as depicted in FIG. 2B is obtained. In particular, the fields 352a and 252b of view of the first camera 140 have circular shapes centered at both eyes of the user 350, and the field 354 of view of the second camera 142 has a substantially circular shape centered at a position below both eyes of the user 350.

In particular, where the position of the lens of the second camera 142 is set to a position in the proximity of between the eyes of the user, the optical axis of the second camera 142 is inclined downwardly with respect to the horizontal plane. Generally, even if the position of the eyes is same, since the line of sight of the user is in most cases inclined somewhat downwardly, this can be coped with by setting the optical axis in such a manner as described above. However, the direction of the optical axis of the second camera 142 is not limited to this. Where the second camera 142 having a wide field of view is provided separately, even if the field of view of the first camera 140 is narrowed, necessary information can be obtained.

Consequently, even if the number of pixels of the first camera 140 is not increased, an image having a high resolution in the field of view of the first camera 140 is obtained. Further, by narrowing the field of view, the distance D between the point of view of the first camera 140 and the actual point of view of the user 350 can be reduced. Consequently, images picked up by the first camera 140 exhibit a state proximate to that when the user views without viewing through the head-mounted display apparatus 100. Accordingly, for example, if parallax images picked up by the first camera 140 are displayed as they are as parallax images for a stereoscopic vision, then the reality can be provided more to the user.

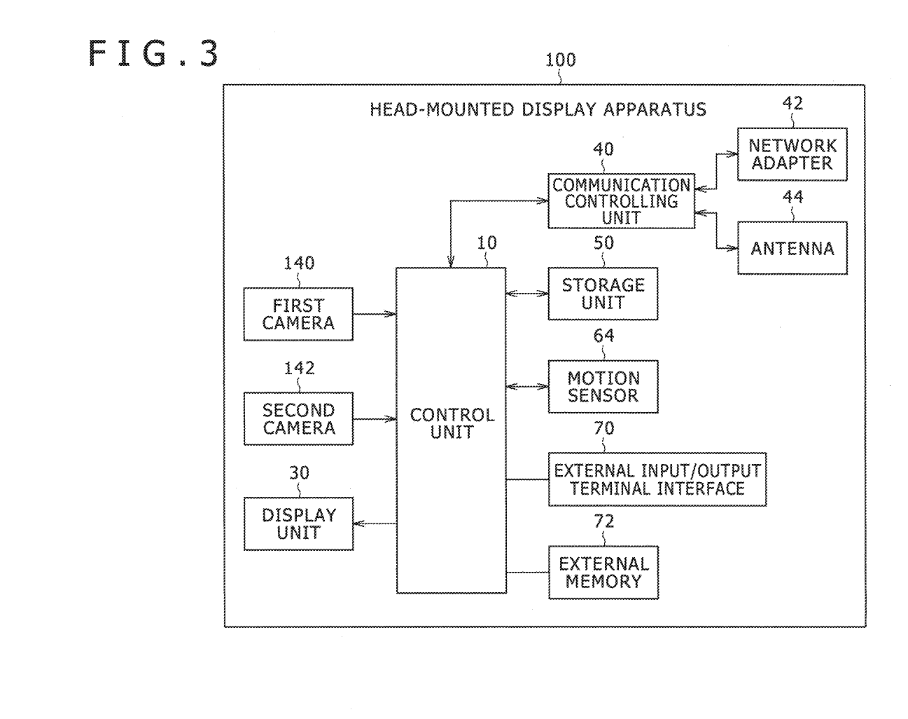

FIG. 3 is a block diagram depicting a functional configuration of the head-mounted display apparatus 100. Referring to FIG. 3, a control unit 10 is a main processor which processes signals such as image signals and sensor signals, instructions and data and output a result of the processing. The first camera 140 and the second camera 142 supply data of picked up images to the control unit 10. A display unit 30 is a liquid crystal display apparatus or the like and receives and displays an image signal from the control unit 10.

A communication controlling unit 40 transmits data inputted from the control unit 10 to the outside by wired or wireless communication through a network adapter 42 or an antenna 44. Further, the communication controlling unit 40 receives data from the outside by wired or wireless communication through the network adapter 42 or the antenna 44 and outputs the data to the control unit 10. A storage unit 50 temporarily stores data, parameters, operation signals and so forth to be processed by the control unit 10.

A motion sensor 64 detects posture information such as a rotational angle or an inclination of the head-mounted display apparatus 100. The motion sensor 64 is implemented by a suitable combination of a gyro sensor, an acceleration sensor, a geomagnetic sensor and so forth. An external input/output terminal interface 70 is an interface for coupling a peripheral apparatus such as a universal serial bus (USB) controller. An external memory 72 is an external memory such as a flash memory. The control unit 10 can supply an image or sound data to the display unit 30 or headphones not depicted so as to be outputted or to the communication controlling unit 40 so as to be transmitted to the outside.

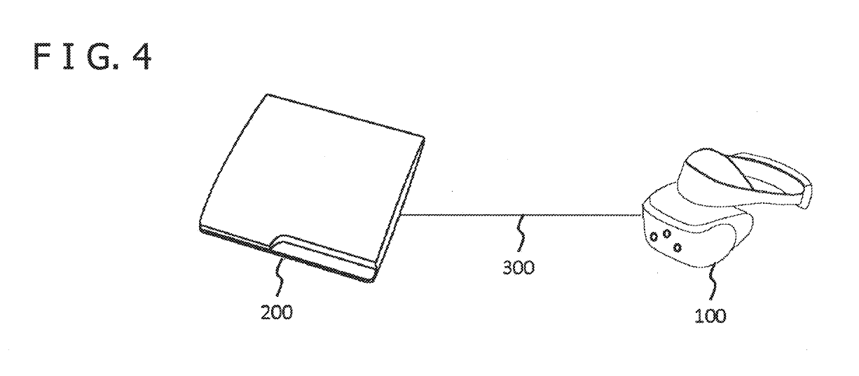

FIG. 4 is a view depicting a configuration of an information processing system according to the present embodiment. The head-mounted display apparatus 100 is coupled to an information processing apparatus 200 by an interface 300 which connects a peripheral apparatus by wireless communication or by a USB bus. The information processing apparatus 200 may be further coupled to a server by a network. In this case, the server may provide an online application of a game or the like in which a plurality of users can participate through the network to the information processing apparatus 200. The head-mounted display apparatus 100 may be coupled to a computer or a portable terminal in place of the information processing apparatus 200.

The information processing apparatus 200 is basically configured such that it repeats, at a predetermined rate, processes of acquiring data of images picked up by the first camera 140 and the second camera 142 of the head-mounted display apparatus 100, performing a predetermined process for the data and generating a display image and then transmitting the display image to the head-mounted display apparatus 100. Consequently, various images of AR, VR and so forth are displayed with a field of view according to the direction of the face of the user on the head-mounted display apparatus 100. It is to be noted that such display may have various final objects such as a game, a virtual experience, watching of a movie and so forth. Although the information processing apparatus 200 may suitably perform a process in accordance with such an object as described above, a general technology can be applied to such a process itself as just described.

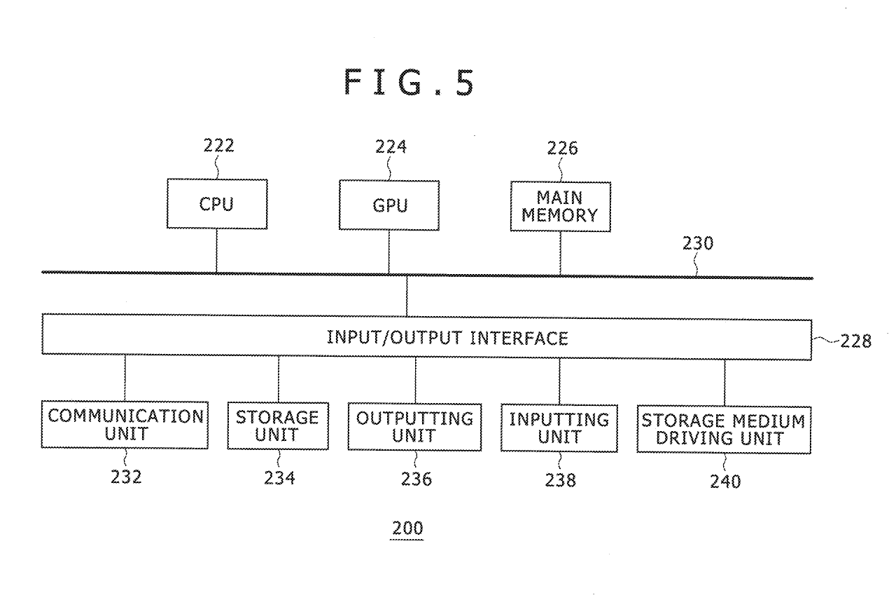

FIG. 5 depicts a configuration of an internal circuit of the information processing apparatus 200. The information processing apparatus 200 includes a central processing unit (CPU) 222, a graphics processing unit (GPU) 224 and a main memory 226. The components mentioned are coupled to each other by a bus 230. Further, an input/output interface 228 is coupled to the bus 230.

To the input/output interface 228, a communication unit 232, a storage unit 234, an outputting unit 236, an inputting unit 238 and a storage medium driving unit 240 are coupled. The communication unit 232 is configured from a peripheral apparatus interface such as a USB or institute of electrical and electronics engineers (IEEE) 1394 interface or a network interface such as a wired or wireless local area network (LAN). The storage unit 234 is configured from a hard disk drive, a nonvolatile memory or the like. The outputting unit 236 outputs data to a display apparatus such as the head-mounted display apparatus 100, and the inputting unit 238 receives data inputted from the head-mounted display apparatus 100. The storage medium driving unit 240 drives a removable recording medium such as a magnetic disk, an optical disk or a semiconductor memory.

The CPU 222 executes an operating system stored in the storage unit 234 to control the overall information processing apparatus 200. Further, the CPU 222 executes various programs read out from a removable recording medium and loaded into the main memory 226 or downloaded through the communication unit 232. The GPU 224 has a function of a geometry engine and a function of a rendering processor, and performs a rendering process in accordance with a rendering instruction from the CPU 222 and stores a display image into a frame buffer not depicted. Further, the GPU 224 converts the display image stored in the frame buffer into a video signal and outputs the video signal to the outputting unit 236. The main memory 226 is configured from a random access memory (RAM) and stores a program or data necessary for processing.

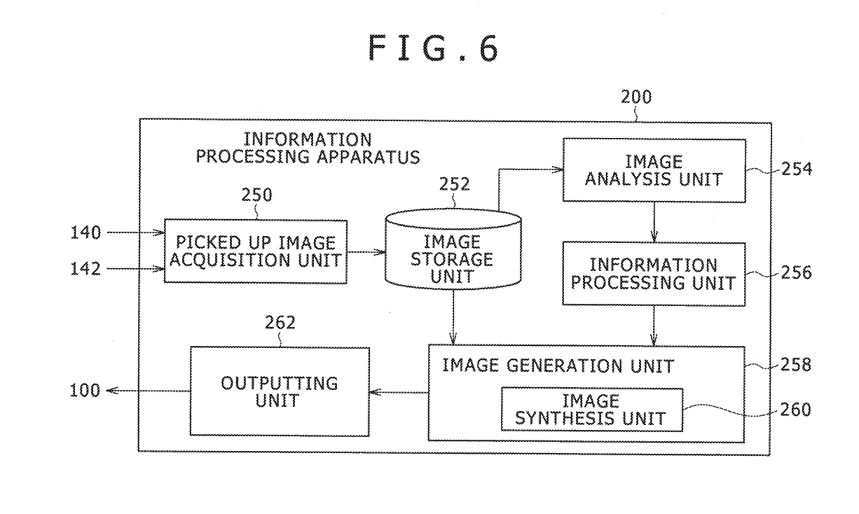

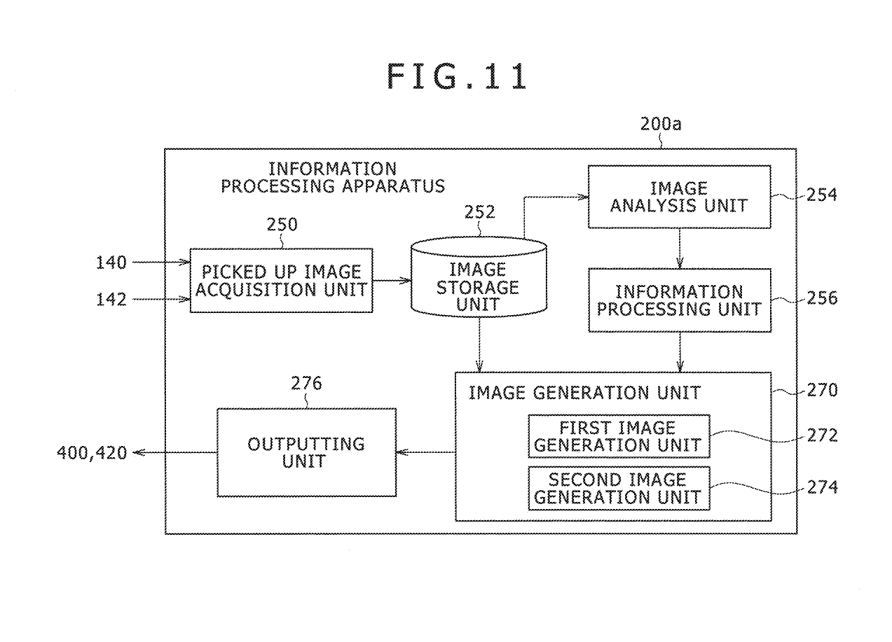

FIG. 6 depicts functional blocks of the information processing apparatus 200 in the present embodiment. It is to be noted that at least part of functions of the information processing apparatus 200 depicted in FIG. 6 may be incorporated in the control unit 10 of the head-mounted display apparatus 100. Further, the functional blocks depicted in FIG. 6 and FIG. 11 hereinafter described can be implemented, in hardware, from such components as a CPU, a GPU, various memories and so forth depicted in FIG. 5 and can be implemented, in software, from a program loaded from a recording medium into a memory and exhibiting various functions such as a data inputting function, a data retaining function, an image processing function and a communication function. Accordingly, it can be recognized by those skilled in the art that the functional blocks mentioned can be implemented in various forms only from hardware, only from software or from a combination of hardware and software but without limited to any of them.

The information processing apparatus 200 includes a picked up image acquisition unit 250, an image storage unit 252, an image analysis unit 254, an information processing unit 256, an image generation unit 258 and an outputting unit 262. The picked up image acquisition unit 250 acquires data of picked up images from the first camera 140 and the second camera 142 of the head-mounted display apparatus 100. The image storage unit 252 stores acquired data, and the image analysis unit 254 analyzes the picked up images to acquire necessary information. The information processing unit 256 performs information processing based on a result of the image analysis and the image generation unit 258 generates data of an image to be displayed as a result of the image processing, and the outputting unit 262 outputs the generated data.

The picked up image acquisition unit 250 acquires data of images picked up by the first camera 140 and the second camera 142 at a predetermined rate, performs necessary processes such as a decoding process and stores a result of the processes into the image storage unit 252. Here, the data acquired from the first camera 140 are data of parallax images picked up from the left and right points of view by the stereo camera.

The image analysis unit 254 successively reads out data of picked up images from the image storage unit 252 and carries out a predetermined analysis process to acquire necessary information. As a representative analysis process, a process for acquiring a position or a posture of the head of a user having the head-mounted display apparatus 100 mounted thereon by such a technology as v-SLAM described hereinabove or a process for generating a depth image is available. The depth image is an image which a distance of an image pickup object from a camera is represented as a pixel value of a corresponding figure on a picked up image and is used to specify a position or a motion of an image pickup object in an actual space.

When a depth image is to be generated, the image analysis unit 254 utilizes parallax images picked up from the left and right points of view of the first camera 140. In particular, the image analysis unit 254 extracts corresponding points from the parallax images and calculates the distance of the image pickup object by the principle of triangulation on the basis of a parallax between the corresponding points. Even if the field of view of the first camera 140 is made narrower than that of a general camera, the influence of this upon a later process which is performed using a depth image generated by the first camera 140 is low. This is because, even if the distance of the image pickup object is determined using a parallax image picked up with a wide field of view, as an article comes near to an end of a field of view, the triangle having apexes at the left and right points of view and the article becomes slender and the calculated distance is less likely to be obtained with a sufficient accuracy.

The image analysis unit 254 may further perform general image analysis suitably. For example, the image analysis unit 254 may model an actual substance existing in an image pickup object space as an object in a computational three-dimensional space on the basis of a generated depth image, or may chase or recognize a an actual substance. A process to be executed here is determined depending upon the substance of image processing or display of a game or the like. Depending upon the substance of analysis, either narrow angle images picked up by the first camera 140 or a wide angle image picked up by the second camera 142 is selected as an analysis target.

For example, when detailed information regarding a target object noticed by the user is to be obtained, it is effective to use narrow angle images of a high resolution. By providing the first camera 140 at a position corresponding to the position of the eyes of the user, the possibility that the field of view of the first camera 140 may include the noticed target of the user is high. Accordingly, if the narrow angle images with which a high resolution is obtained with the field of view are used, then an image recognition process or a like process for identifying a person or an object can be performed with a high degree of accuracy.

On the other hand, as regards an end of a field of view displaced far from a noticed target, since the possibility that detailed information may be required is low, necessary information can be obtained efficiently by performing analysis using a wide angle image having a low resolution. For example, by utilizing a wide angle image, it can be implemented with a load of a small amount of processing to detect an article entering a field of view space or to acquire the brightness of an entire image in order to adjust an image pickup condition or a processing condition.

The information processing unit 256 performs predetermined information processing making use of a result of analysis performed by the image analysis unit 254. For example, the information processing unit 256 physically determines an interaction between a modeled actual substance and a virtual object to be rendered by computer graphics, adds an element of a game to a display image, or interprets a gesture of a user to implement a predetermined function. Also a process to be performed in the information processing unit 256 is determined depending upon the substance of image processing or display of a game or the like.

The image generation unit 258 generates an image to be displayed as a result of processing performed by the information processing unit 256. For example, when AR is to be implemented, the image generation unit 258 reads out data of picked up images from the image storage unit 252 and renders a virtual object on the picked up images such that a motion determined by the information processing unit 256 may be represented. The image generation unit 258 includes an image synthesis unit 260. The image synthesis unit 260 synthesizes narrow angle images picked up by the first camera 140 and a wide angle image picked up by the second camera 142.

In particular, in a region corresponding to the field of view of the first camera 140 from within an image of a wide field of view picked up by the second camera 142, the image portion is replaced by the images picked up by the first camera 140. It is to be noted that the images of the first camera 140 and the image of the second camera 142 are suitably reduced or magnified such that figures of the same image pickup object are represented in the same size. Typically, the figure of the wide angle image is magnified so as to have a size same as the size of the narrow angle images, and then the wide angle image and the narrow angle images are joined together. This provides an image of a wide angle in which the resolution is high in a predetermined region in the proximity of the center or the like. Where AR is to be implemented, a virtual object is rendered before or after such synthesis.

It is to be noted that the synthesis target is not limited to a picked up image. In particular, if an image is obtained in a field of view corresponding to a wide angle image and a narrow angle image, then it can be synthesized similarly even if it is partly or entirely rendered by the image generation unit 258. For example, a graphics image in which all image pickup objects are rendered as an object may be used. Further, when parallax images are to be displayed on the head-mounted display apparatus 100 to implement a stereoscopic vision, two synthesis images for being viewed by the left eye and the right eye are generated and juxtaposed on the left and the right to obtain a final display image. The outputting unit 262 acquires data of the display image from the image generation unit 258 and successively transmits the data to the head-mounted display apparatus 100.

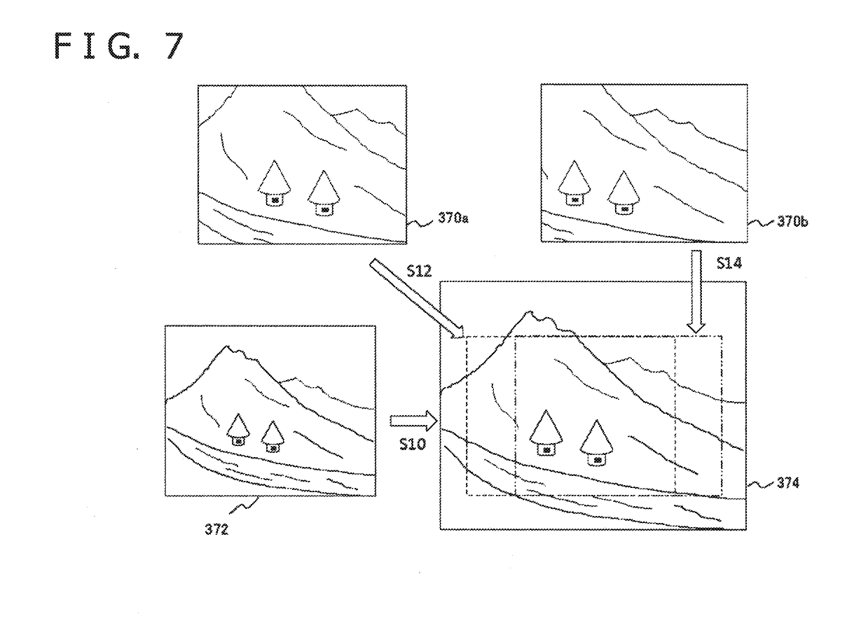

FIG. 7 schematically illustrates a procedure performed by the image generation unit 258 for generating a display image using picked up images. First, images 370a and 370b are narrow angle images picked up from the left and right points of view by the first camera 140. An image 372 is a wide angle image picked up by the second camera 142. In the example depicted, the images 370a, 370b and 372 have sizes similar to each other, in some cases, the image 372 may have a further smaller size.

The image synthesis unit 260 of the image generation unit 258 adjusts the size of the images such that figures of the same image pickup object may have a same size and correspond to the size of the display apparatus as described hereinabove. For example, the image synthesis unit 260 magnifies the wide angle image 372 (S10). Then, data in a region represented by the narrow angle image 370a or 370b from among the magnified images are replaced by the narrow angle image 370a or 370b (S12 and S14). Consequently, an image 374 of a wide angle in which a region in the proximity of the center has a high definition is generated.

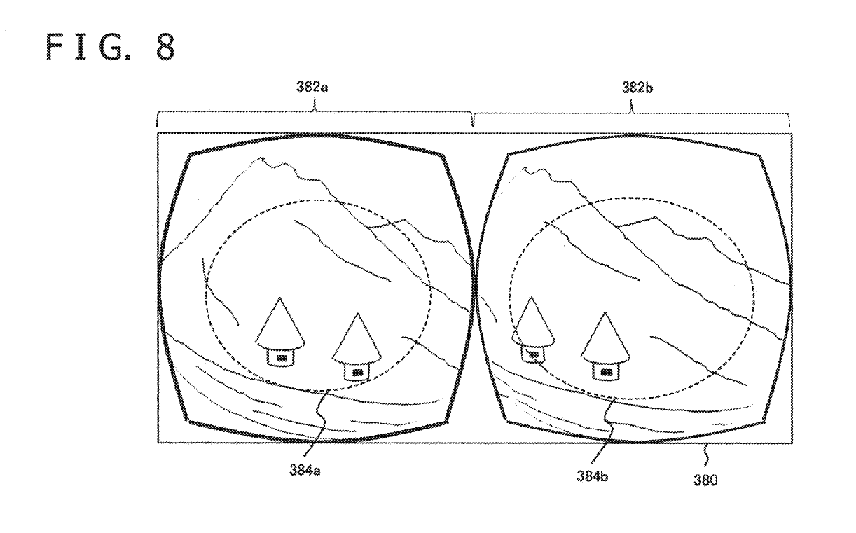

It is to be noted that, although only one image is depicted as the image 374 in FIG. 7, if the narrow angle image 370a from the left point of view and the narrow angle image 370b from the right point of view are synthesized independently of each other with a magnified image at a corresponding position, then display images for the left eye viewing and the right eye viewing can be generated, and therefore, a stereoscopic vision becomes possible. FIG. 8 exemplifies an image generated finally by the image generation unit 258 in order to implement a stereoscopic vision in such a manner as described above.

The display image 380 is configured from a region 382a for the left eye viewing on the left side and a region 382b for the right eye viewing on the right side from between regions into which the region of the display image 380 is divided leftwardly and rightwardly. By viewing the images in the regions with the fields of view magnified by the lenses provided in front of the eyes, the user can experience an image world which looks stereoscopically over the overall field of view of the user. In this case, the image generation unit 258 applies reverse distortion correction taking distortion of the images by the lenses into consideration. The images before the correction are an image for the left eye viewing and an image for the right eye viewing generated in such a manner as described hereinabove with reference to FIG. 7.

In particular, of the image represented in the region 382a for the left eye viewing, a region 384a in the proximity of the center indicates an image picked up by the camera at the left point of view of the first camera 140 while the remaining region indicates an image picked up by the second camera 142. Meanwhile, of the image represented in the region 382b for the right eye viewing, a region 384b in the proximity of the center indicates an image picked up by the camera at the right point of view of the first camera 140 while the remaining region indicates an image picked up by the second camera 142. Although the image picked up by the second camera 142 has display regions displaced from each other as a result of clipping for the left eye viewing and the right eye viewing, the same image is used in the display regions.

For joining of images having different fields of view, an existing technology such as stitching can be utilized. Further, since an image obtained by magnifying a wide angle image and a narrow angle image have different resolutions from each other, a region in the proximity of each joint indicated by a dotted line in FIG. 8 is indicated in an intermediate state between the images and the resolution is gradually varied to make the joint less likely to be visually recognized. For the generation of an intermediate state between the two images, a technology for morphing can be utilized. It is to be noted that, since strictly a wide angle image and a narrow angle image have different points of view of the cameras from each other, although an apparent difference appears particularly with an article at a short distance, the continuity can be directed by representing a joint in an intermediate state.

With the present embodiment described above, by introducing a first camera and a second camera which have fields of view different from each other and complementarily utilizing narrow angle images and a wide angle image picked up by the first and second cameras for image analysis or image display, the number of pixels of the individual picked up images can be suppressed. As a result, information of a wider field of view can be determined as a processing target or a displaying target without increasing the amount of data to be handled. Originally, to a person, a region noticed particularly from within a field of view is restrictive, and the person synthesizes detailed information in such a noticed region and rough information around the noticed region to obtain visual information. Since display which utilizes a narrow angle high resolution image and a wide angle low resolution image matches with such a characteristic as just described, the incompatibility is low, and both of increase in angle and immediacy of display can be satisfied while a definition for a necessary portion is maintained.

It is to be noted that to dispose an image of a high resolution picked up by the first camera positioned near to the point of view of the user at the center of the field of view of the user with respect to the head-mounted display apparatus is most effective to artificially create a world to be viewed by the user. On the other hand, the present embodiment is not limited to this, and for example, an image pickup apparatus including the first camera 140 and the second camera 142 may be provided separately from the head-mounted display apparatus 100. Further, the display apparatus is not limited to a head-mounted display apparatus. For example, the user may have an image pickup apparatus mounted on its head such that images picked up by the image pickup apparatus are synthesized in such a manner as described above and displayed on a display apparatus of the stationary type prepared separately.

Even where the display apparatus is configured in this manner, a wide angle image in which a significant target the user faces is depicted in detail can be displayed immediately with the load of processing reduced. Further, where a stereoscopic vision is not required, the first camera which picks up an image of a narrow angle and a high resolution may not be a stereo camera, and anyway, image analysis of an image of a significant target whose image is picked up by the first camera can be performed particularly, it is possible to display a wide angle image while the amount of data is suppressed and besides obtain necessary information or represent a significant portion in a high resolution.

### Second Embodiment

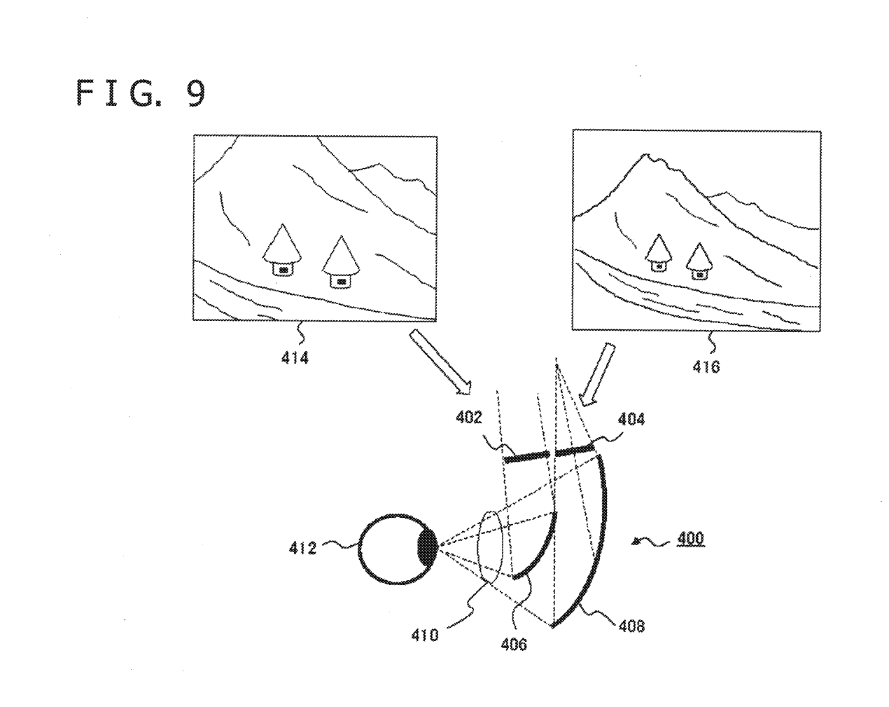

In the first embodiment, a display image is generated by synthesizing images of different resolutions. In the present embodiment, a mechanism for synthesizing images optically on the head-mounted display apparatus side. The appearance shape of the head-mounted display apparatus, the configuration of an information processing system and the configuration of an internal circuit of an information processing apparatus may be similar to those in the first embodiment. In the following, description is given taking notice of differences of the present embodiment from the first embodiment. FIG. 9 is a side elevational view schematically depicting an example of an internal structure of a head-mounted display apparatus 400 of the present embodiment.

The head-mounted display apparatus 400 is a display apparatus of the type in which an image displayed on a display unit is reflected by a reflector such that the image arrives at the eyeballs of an observer. Such a head-mounted display apparatus which utilizes reflection of light is well-known as disclosed in Japanese Patent Laid-Open Nos. 2000-312319, 1996-220470, and 1995-333551. The head-mounted display apparatus 400 of the present embodiment includes two sets of a display unit and a reflector such that two images are optically synthesized.

In particular, an image displayed on a first display unit 402 is reflected by a first reflector 406 while an image displayed on a second display unit 404 is reflected by a second reflector 408. Then, the reflected images are introduced to an eye 412 of a user through a lens 410. The first reflector 406 is smaller than the second reflector 408 and is disposed in an overlapping relationship with the second reflector 408 between the eyeball of the user and the second reflector 408. By the configuration just described, a portion, which is hidden by the first reflector 406, of the image reflected from the second reflector 408 does not seen to the user but is replaced by the image reflected from the first reflector 406.

In the head-mounted display apparatus 400 having such a configuration as described above, if a narrow angle image and a wide angle image are displayed on the first display unit 402 and the second display unit 404, respectively, then the images are visually recognized in a state in which they are synthesized with each other. For example, if a narrow angle image 414 picked up by the first camera 140 of the first embodiment is displayed on the first display unit 402 and a wide angle image 416 picked up by the second camera 142 is displayed on the second display unit 404, then such an image of a wide angle which has a high resolution in a partial region thereof as is implemented by the first embodiment can be presented.

In this case, the images are magnified by the reflectors, and the magnification factor of the image displayed on the first display unit 402 and the magnification factor of the image displayed on the second display unit 404 can be controlled independently of each other by an optical design. Therefore, even if the wide angle image 416 is to be presented in a further magnified state, the display unit itself which displays the wide angle image 416 can be reduced in size. Accordingly, while the fabrication cost is suppressed, the reduction effect of the load required for a magnification process or for data transmission particularly of the wide angle image 416 is enhanced.

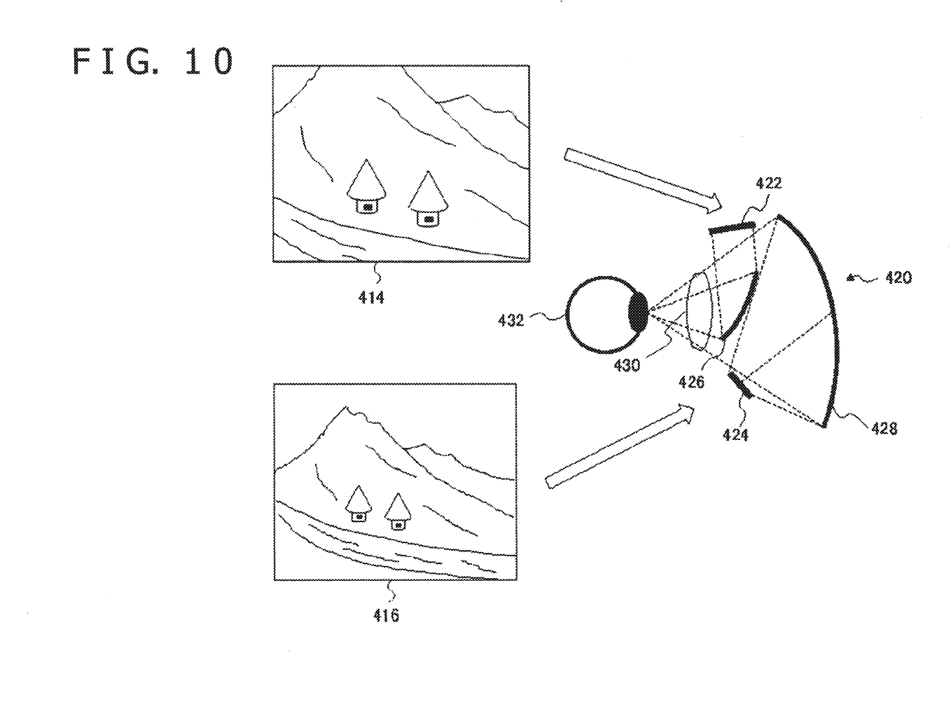

FIG. 10 is a side elevational view schematically depicting a different example of the internal structure of a head-mounted display apparatus 420. Also in the present example, an image displayed on a first display unit 422 is reflected by a first reflector 426 while an image displayed by a second display unit 424 is reflected by a second reflector 428. Then, both images are introduced to an eye 432 of the user through a lens 430. However, in this example, while the first display unit 422 introduces an image from above similarly to the configuration of the head-mounted display apparatus 400 of FIG. 9, the second display unit 424 introduces an image from below.

With the configuration of FIG. 10, since the degree of freedom in angle of the display units and the reflectors increases and the magnification factor can be raised in a limited space, reduction of the cost by reduction in size of the display units can be achieved in addition to the decrease of the load of processing described hereinabove with reference to FIG. 9. Also in this case, a portion, which does not viewed due to the first reflector 426, of an image reflected by the second reflector 428 is replaced by the image reflected by the first reflector 426. For example, if the narrow angle image 414 picked up by the first camera 140 in the first embodiment is displayed on the first display unit 422 and the wide angle image 416 picked up by the second camera 142 is displayed on the second display unit 404, then such an image of a wide angle having a high resolution in a partial region as is implemented in the first embodiment can be presented.

If such a set of a display unit and a reflector as depicted in a side elevational view in FIG. 9 or 10 is provided for each of the left eye and the right eye and picked up images from the left and right points of view are synthesized with an image formed by suitably clipping a wide angle image, then an image similar to that depicted in FIG. 8 can be presented. Further, while the optical system in the examples depicted in FIGS. 9 and 10 includes only a concave mirror and a lens, if a free-form surface mirror is used or a prism or a further reflector is combined or the like, then reduction in size or high-accuracy distortion correction of the apparatus can be implemented. Such an optical system as just described is placed in practical use in a camera, a projector and so forth of a bending optical system.

The head-mounted display apparatuses 400 and 420 may have a functional configuration similar to that of the head-mounted display apparatus 100 depicted in FIG. 3. However, as the display unit 30, two display units including a first display unit and a second display unit are provided as described hereinabove. FIG. 11 depicts functional blocks of an information processing apparatus 200a of the present embodiment. In FIG. 11, blocks of the information processing apparatus 200a having like functions to those of the information processing apparatus 200 of the first embodiment depicted in FIG. 6 are denoted by like reference numerals and overlapping description of them is omitted herein.

An image generation unit 270 of the information processing apparatus 200a generates an image to be displayed as a result of processing performed by the information processing unit 256. Although this function is basically similar to that in the first embodiment, the image generation unit 270 includes a first image generation unit 272 and a second image generation unit 274 in place of the image synthesis unit 260. The first image generation unit 272 and the second image generation unit 274 generate images, which are to be displayed on the first display unit 402 and the second display unit 404 of the head-mounted display apparatus 400 or on the first display unit 422 and the second display unit 424 of the head-mounted display apparatus 420, independently of each other.

When a stereoscopic vision is to be implemented by parallax images on the head-mounted display apparatuses 400 and 420, the first image generation unit 272 generates a narrow angle image for the left eye viewing and a narrow angle image for the right eye viewing, and the second image generation unit 274 generates a wide angle image for the left eye viewing and a wide angle image for the right eye viewing. In a mode in which a picked up image is displayed, narrow angle images from the left and right points of view picked up by the first camera 140 are utilized as the narrow angle image for the left eye viewing and the narrow angle image for the right eye viewing. On the other hand, the second image generation unit 274 suitably clips a wide angle image picked up by the second camera 142 into an image for the left eye viewing and an image for the right eye viewing.

Further, a magnification or reduction process, clipping, distortion correction and so forth are suitably performed such that a normal image can be seen when the image undergoes reflection and passing through a lens in accordance with the optical system depicted in FIG. 9 or 10. For correction calculation for each individual system including a display unit, a reflector and a lens, a technology having been placed into a practical use can be applied. Further, necessary parameters such as a magnification or reduction ratio of an image or a region to be clipped can be determined in advance in accordance with the overlapping degree in the reflector of the head-mounted display apparatuses 400 and 420, the size of the reflector, the size of the display unit, the distance between the display unit and the reflector and so forth.

Further, similarly as in the first embodiment, the first image generation unit 272 may place a periphery of a generated display image into an intermediate state between the display image and the image of a low resolution by morphing or the like such that the boundary between the images by the two reflectors may be seen natural. Alternatively, the second image generation unit 274 may place a periphery of a region, which is hidden by the first reflector, of the generated display image into an intermediate state between the display image and the high resolution image or may combine the two cases.

An outputting unit 276 acquires data of a display image from the image generation unit 270 and successively transmits the data to the head-mounted display apparatus 400 or the head-mounted display apparatus 420. While, in the first embodiment, data of one display image for one frame is transmitted, in the second embodiment, where a stereoscopic vision is to be displayed, data of totaling four display images are transmitted. However, if optical magnification is taken into consideration, then the data of the individual images to be transmitted have a comparatively small size.

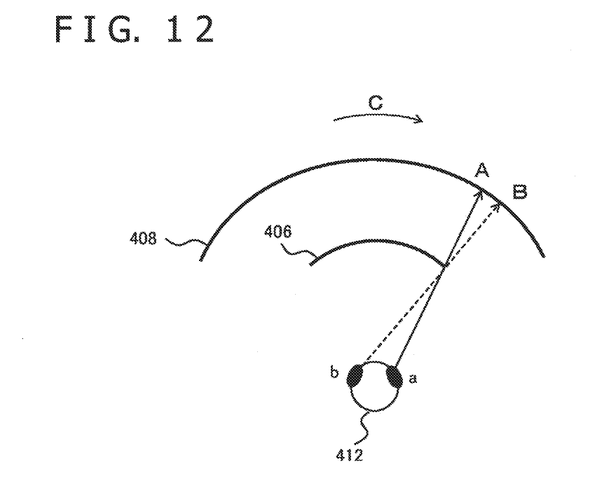

As described above, where two display images are physically overlapped with each other, strictly an apparent displacement appears with the overlap between the display images depending upon the direction of a pupil. FIG. 12 is a view illustrating a displacement caused by two images depending upon the direction of a pupil and schematically illustrates an overhead manner of the first reflector 406 and the second reflector 408 in the head-mounted display apparatus 400 and the eye 412 of the user. When the pupil of the user is directed as indicated by a, at an edge of the first reflector 406, a portion A of the image of the second reflector 408 is visible.

On the other hand, when the pupil of the user is directed as indicated by b, at the same edge of the first reflector 406, a portion B of the image of the second reflector 408 is visible. Accordingly, if the display regions of images from the two reflectors are adjusted such that the images look connected to each other when the pupil is positioned at the position a, then when the pupil is positioned at the position b, the two images look discontinuous. Note that, when the pupil is positioned at the position b, since the edge of the first reflector 406 comes to an end of the field of view, this does not give a significant discomfort. For example, if the display regions are adjusted such that the two images look connected to each other at all edges of the first reflector 406 when the pupil is directed to the front, then the displacement can be suppressed to the minimum irrespective of the direction of the pupil.

On the other hand, the region of an image to be displayed may be adjusted in accordance with the direction of the pupil such that no such displacement occurs. For example, a gazing point detector is provided in the head-mounted display apparatuses 400 and 420. The gazing point detector is a device which detects infrared rays irradiated from an infrared irradiation mechanism and reflected by the pupil and detects a gazing point from the direction of the pupil specified from the detected infrared rays. A result of the detection is utilized to specify the direction of the pupil, and the display region is displaced in response to a variation of the direction of the pupil such that the two images always look connected.

In this case, the information processing apparatus 200a acquires a result of the detection of the gazing point detector. Then, the first image generation unit 272 or the second image generation unit 274 varies the region on an image to be clipped as a display image in response to the direction of the pupil. For example, when the pupil moves from the position a toward the position b, the second image generation unit 274 varies the clipping region of the display image such that the image moves in a direction indicated by an arrow mark C. By the configuration, the position of an image on the second reflector 408 which looks at an edge of the first reflector 406 becomes always same, and the discomfort caused by a gap between the two reflectors can be reduced.

Also in the second embodiment, the display target is not limited to a picked up image. In particular, the present embodiment can be applied also to a technology such as VR in which an overall area is rendered by computer graphics. In this case, for a significant portion of the image, for example, for a region watched by a user, rendering is performed in a high resolution by the first image generation unit 272, and a full image of a wide angle is rendered in a low resolution by the second image generation unit 274. Then, if the former image is displayed on the first display unit while the latter is displayed on the second display unit, then the images can be presented optically synthetically.

Even in this case, the load of a rendering process or data transmission is lower than that when rendering for the full area is performed in a high resolution. In other words, while the definition in a necessary portion is maintained, both of increase in angle and immediacy of display can be anticipated. In such a mode as just described, one or both of the first camera 140 and the second camera 142 may not be provided on the head-mounted display apparatus. The cameras may also be provided as separate apparatus from the head-mounted display apparatus.

With the embodiment described above, in a head-mounted display apparatus in which an image displayed on a display unit is introduced to the eyes of a user by a reflector, reflectors having sizes different from each other are disposed in an overlapping relationship as viewed from the user and different images are reflected on the reflectors. Here, a wide angle image is reflected by a greater one of the reflectors while a narrow angle image is reflected by a smaller one of the reflectors which is placed on the near side to the user such that the images look in a synthesized state to the user.

Consequently, even if the size of an image to be displayed on the display unit is small, a wide angle image can be presented over a wide field of view to the user, and besides an image in a significant region can be represented in a high definition. Therefore, a wider angle image can be displayed immediately while the load of processing and transmission is light and a necessary definition is maintained. Further, by combining the mode described with another mode in which cameras having different angles of view are provided in a head-mounted display apparatus, a display image can be outputted with internal image processing minimized, and consequently, image display with reduced latency can be implemented.

The present embodiment has been described in connection with the embodiments thereof. The embodiments are exemplary, and it can be recognized by those skilled in the art that various modifications are possible to a combination of the components and processes of the embodiments and that also such modifications are included within the scope of the present disclosure.

The present technology contains subject matter related to that disclosed in Japanese Priority Patent Application JP 2016-094079 filed in the Japan Patent Office on May 9, 2016, the entire content of which is hereby incorporated by reference.

What is claimed is:

1. An image pickup apparatus adapted to pick up an image to be used for generation of a display image at a predetermined rate, comprising:
a first camera configured to pick up an image of an image pickup object space;
a second camera configured to pick up an image of the image pickup object space with a wider field of view and a lower resolution than those of the first camera; and
an outputting unit configured to successively output data of the images picked up by the first camera and the second camera.

2. The image pickup apparatus according to claim 1, wherein the first camera picks up two moving images, which have a parallax, from left and right points of view having a known distance, and
the second camera picks up one moving image from a point of view on a vertical line which passes a midpoint between the left and right points of view.

3. The image pickup apparatus according to claim 1, further comprising:
a mounting mechanism unit configured to implement fixation of the image pickup apparatus to the head of a user, wherein
the first camera and the second camera individually have fields of view which vary in response to the direction of the face of the user.

4. The image pickup apparatus according to claim 1, wherein the second camera has an optical axis inclined downwardly from a horizontal plane.

5. A head-mounted display apparatus, comprising:
an image pickup apparatus adapted to pick up an image to be used for generation of a display image at a predetermined rate, including: a first camera configured to pick up an image of an image pickup object space, a second camera configured to pick up an image of the image pickup object space with a wider field of view and a lower resolution than those of the first camera, and an outputting unit configured to successively output data of the images picked up by the first camera and the second camera; and
a display unit configured to display a display image synthesized from an image picked up by the first camera and an image picked up by the second camera.

6. A head-mounted display apparatus, comprising:
a first display unit and a second display unit each configured to display an image; and
a first reflector and a second reflector configured to reflect the images displayed by the first display unit and the second display unit in a direction toward the eyes of a user, respectively, wherein
the first reflector is smaller than the second reflector and is disposed between the eyes of the user and the second reflector.

7. The head-mounted display apparatus according to claim 6, wherein the first display unit displays part of the image displayed by the second display unit with a resolution higher than that of the image displayed by the second display unit.

8. The head-mounted display apparatus according to claim 6, wherein the image displayed by the first display unit and the image displayed by the second display unit are magnified at magnification factors different from each other by the first reflector and the second reflector, respectively.

9. The head-mounted display apparatus according to claim 6, wherein two display mechanisms each configured from the first display unit, second display unit, first reflector and second reflector are provided and configured to allow the left and right eyes of the user to visually recognize an image for left eye viewing and an image for right eye viewing, respectively.

10. The head-mounted display apparatus according to claim 6, further comprising:
a first camera configured to pick up an image of an image pickup object space with a field of view corresponding to the direction of the face of a user; and
a second camera configured to pick up an image of the image pickup object space with a wider field of view and a lower resolution than those of the first camera, wherein
the first display unit displays an image based on the image picked up by the first camera and the second display unit displays an image based on the image picked up by the second camera.

11. The head-mounted display apparatus according to claim 6, further comprising:
a detector configured to acquire the direction of a pupil of the user, wherein
one of the first display unit and the second display unit displays an image whose display region varies in response to the direction of the pupil of the user.

12. An information processing system, comprising:
an image pickup apparatus adapted to pick up an image to be used for generation of a display image at a predetermined rate, including: a first camera configured to pick up an image of an image pickup object space, a second camera configured to pick up an image of the image pickup object space with a wider field of view and a lower resolution than those of the first camera, and an outputting unit configured to successively output data of the images picked up by the first camera and the second camera; and
an information processing apparatus configured to acquire data of an image outputted from the image pickup apparatus, synthesize the image picked up by the first camera and the image picked up by the second camera to generate a display image, and output the display image to a display apparatus.

13. The information processing system according to claim 12, wherein the information processing apparatus synthesizes two images, which have a parallax, picked up from left and right points of view having a known distance by the first camera with one image picked up from a point of view on a vertical line passing a midpoint between the left and right points of view by the second camera to generate parallax images for a stereoscopic vision and outputs the parallax images.

14. The information processing system according to claim 12, wherein the information processing apparatus performs image analysis selectively using one of the image picked up by the first camera and the image picked up by the second camera and reflects a result of the analysis upon the display image.

15. An information processing system, comprising:
a head-mounted display apparatus, including: a first display unit and a second display unit each configured to display an image, and a first reflector and a second reflector configured to reflect the images displayed by the first display unit and the second display unit in a direction toward the eyes of a user, respectively, wherein the first reflector is smaller than the second reflector and is disposed between the eyes of the user and the second reflector; and
an information processing apparatus configured to generate images to be displayed on the first display unit and the second display unit and output the images to the head-mounted display apparatus.

16. An information processing method, comprising:
acquiring data of images picked up by a first camera configured to pick up an image of an image pickup object space and a second camera configured to pick up an image of the image pickup object space with a wider field of view and a lower resolution than those of the first camera;
generating a display image by synthesizing the image picked up by the first camera and the image picked up by the second camera; and
outputting data of the display image to a display apparatus.

17. A computer program for a computer, comprising:
by a picked up image acquisition unit, acquiring data of images picked up by a first camera configured to pick up an image of an image pickup object space and a second camera configured to pick up an image of the image pickup object space with a wider field of view and a lower resolution than those of the first camera;
by an image synthesis unit, generating a display image by synthesizing the image picked up by the first camera and the image picked up by the second camera; and
by an outputting unit, outputting data of the display image to a display apparatus.
